(19) United States
(12) Patent Application Publication
(10) Pub. No.: US 2007/0067269 A1
(43) Pub. Date: Mar. 22, 2007

(54) User Interface

(75) Inventors: Wayne N. Rudge, Reading (GB); Erroll Elliston, London (GB); Asif Qureshi, Hertford (GB); Martin Cholkowski, Letchworth (GB)

Correspondence Address: FAY SHARPE LLP, 1100 SUPERIOR AVENUE, SEVENTH FLOOR, CLEVELAND, OH, 44114, US

(73) Assignee: XEROX CORPORATION

(21) Appl. No.: 11/233,280

(22) Filed: Sep. 22, 2005

(51) Int. Cl. G06F 17/30

(52) U.S. Cl. 707/3

(57) ABSTRACT

A machine with a user interface employs a reader to obtain user interface preferences from an electronic tag residing with the user and uses the user interface preferences to customize the user interface for the user.

### BACKGROUND

The following relates to user interfaces. It finds particular application to automatically customizing a user interface for a user based on an electronic user profile carried by the user.

Many electronic devices (e.g., computers, printing platforms, cell phones, microwaves, automobiles, etc.) include user interfaces that facilitate providing information to and/or receiving information from such devices. For instance, a conventional cell phone typically includes a display that shows a phone number as it is entered by a user. Upon invoking dialing, the cell phone may provide status information to the user via the display such as “dialing,” “connecting,” etc. Depending on whether or not the connection succeeds, the cell phone may display status information such as “connected,” “busy,” “call ended,” etc. The cell phone user interface may also display graphics, for example, signal strength bars, a picture of the other party, an envelope indicating a message is available, a battery showing remaining battery life, a bell indicating an alarm has been set, etc.

Depending on the particular electronic device, the user interface may be relatively simple or complex. For example, a typical microwave user interface may include one or more seven-segment displays and/or light emitting diodes (LEDs) for showing the time of day, the amount of time left in an executing job, error codes, various indicia related to default settings (e.g., “popcorn,” “defrost,” etc.), a timer, etc. Some microwaves may additionally and/or alternatively leverage liquid crystal and/or other types of display technologies in order to enhance user interface appearance. In another example, an automobile dashboard may incorporate displays for speed, mileage, fuel level, temperature, etc., various dummy lights such as “check engine soon,” “oil,” etc., and/or back-lighting for evening and/or nighttime driving. In contrast, conventional computers (e.g., desktop, laptop, handheld, etc.) provide a relatively sophisticated Graphical User Interface (GUI). For instance, a typical computer user interface includes numerous soft (e.g., software based) buttons, knobs, controls, menus, sliders, dials, check boxes, drop down lists, etc. that are invoked through various mechanisms such as a keyboard, a mouse, a digital pen, a microphone, a touch-screen, etc. In addition, the typical computer user interface can be configured with different (e.g., default and custom) aesthetically pleasing backgrounds, color schemes, animations, images, font styles, icons, etc.

User interfaces can be relatively generic, for example, designed to present basic features that may be representative of the most used features (e.g., as determined by the manufacturer) and/or that accommodate novice users. Some of these user interfaces are static and cannot be changed. For instance, the basic microwave seven-segment display noted above. Other user interfaces may support user customization. Typically, customization is achieved by manual configuration. For instance, upon accessing the device (e.g., via logon, password, etc.), the user can observe the various user interface configuration options and either select one or more alternatives to the default interface or retain the default settings. In some instances, one or more additional options can be loaded to the device and selected during customization. For instance, the user may load a personal image (e.g., a picture of the user's family) to the device and use the personal image as the background instead of the default and/or provided alternatives. The user can save the configuration such that the customized settings are used the next time the device is accessed, or revert back to the default settings.

User interface changes can be stored in a user profile, which typically is created for each user of the device and stored on the device. Depending on the device, each user of the device may be able to customize their profile with preferred user interface settings. However, in some instance all users may be subject to the same user interface configuration, or a system administrator may additionally and/or alternatively impose one or more user interface limitations on users of the administrated device(s). Storing such profiles on the device consumes device memory. In addition, processing cycles are consumed for managing the stored profiles.

A user who desires to use the same user interface customization across two or more devices typically has to manually create a profile for each of the devices and re-enter the same options and/or preferences for each profile. Creating profiles for each device and manually setting preference consumes time. In some instances, user profiles can be ported or migrated across devices, which mitigates having to manually configure settings across devices. However, a user interface preference change on any one of the devices is not automatically conveyed to any of the other devices. Rather, the user has to manually make the change and/or migrate the modified profile to the other similar devices.

### BRIEF DESCRIPTION

In one aspect, a machine includes a control component that customizes a user interface of the machine for a user based at least in part on personal user interface preferences. The machine further includes a reader that obtains the personal user interface preferences for an electronic tag residing with the user.

### BRIEF DESCRIPTION OF THE DRAWINGS

FIG. 1 illustrates a system employing an adaptive custom user interface that is customized based on user interface preferences stored within an electronic storage device carried by the user;

FIG. 2 illustrates the system of FIG. 1 in which the user interface preferences within the storage device are updated based on user activity;

FIG. 3 illustrates a method for using user preferences to customize a user interface of a machine;

FIG. 4 illustrates a method for using user preference to customize a user interface of a printing platform; and

FIG. 5 illustrates a printing architecture that employs an adaptive custom user interface.

### DETAILED DESCRIPTION

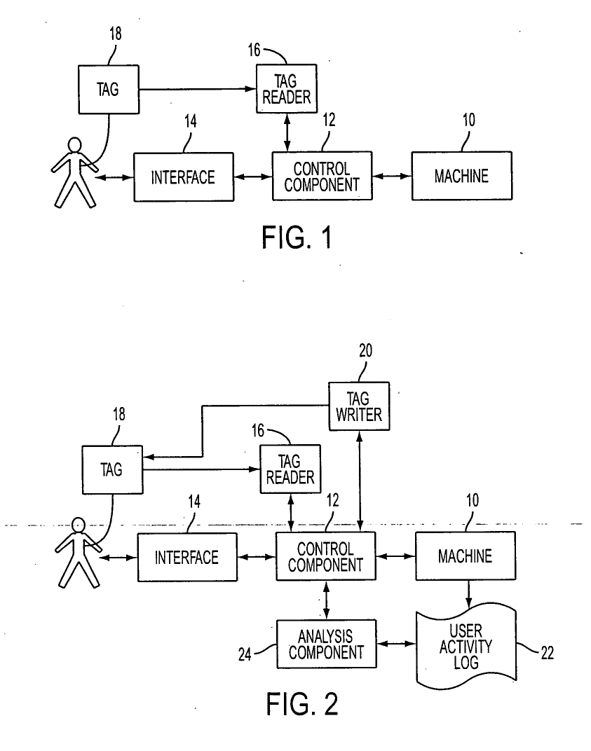

With reference to FIG. 1, a system employing an adaptive custom user interface is illustrated. The system includes a machine 10, which can be, but is not limited to, a printing platform, a computer, a personal data assistant (PDA), an automobile, an entertainment system, a security system, a cell phone, a navigation system, an appliance, etc., and/or essentially any state machine. The machine 10 is controlled, at least in part, by a control component (“controller”) 12, which can be associated with one or more processing components (not shown), storage components (not shown), etc. residing within and/or external to the machine 10.

An interface 14 provides a mechanism in which a user (e.g., a person, a robot, an application, another machine, etc.) can interact with the machine 10. For instance, the machine 10 can use the interface 14 to provide information to the user and/or request input from the user. In another instance, the user can provide information (e.g., parameters, variables, instructions, etc.) to the machine 10 through the interface 14.

The system further includes a tag reader 16, which can read information from suitable electronic storage components such as a tag 18, which can be, but is not limited to, a Radio Frequency IDentification (RFID) tag, a contact-less smart card, a magnetic card, a data key, a transponder, and/or other electromagnetic based information storage component. The tag reader 16 can use wired and/or wireless technologies to read from the tag 18. For instance, the reader 16 may include componentry to wirelessly read and/or receive information from RFID tags. As such, the reader 16 can employ RFID technology to query the tag 18, read information from the tag 18, and/or receive information emitted by the tag 18. In another instance, information can be conveyed between the tag 18 and the reader 16 via a wired and/or wireless Ethernet port. Other suitable wireless network technologies include, but are not limited to, Bluetooth, ZigBee, WiFi, WiMax, PCS, cellular, etc. and/or variations thereof and/or combinations thereof. Likewise, the reader can additionally and/or alternatively include technology to obtain information from contact-less smart cards, magnetic cards, data keys, transponders, and/or other information storage components. For instance, the tag 18 may be a magnetic card wherein information is conveyed between the tag 18 and the reader 16 upon moving the tag 18 through a magnetic field associated with the reader 16.

The tag 18 can be variously attached to the user. For example, the tag 18 can be incorporated in a badge, a personal preference card, a license, a key chain, a bracelet, a necklace, clothing, an adhesive patch, a sticker, a magnet, packaging, a crate, etc. In addition, the tag 18 can be carried by the user.

The tag 18 can store various information. For example, in one instance the tag 18 can store information (e.g., one or more user profiles) associated with one or more particular users, groups of users, etc. Such information can include, but is not limited to, identification, security clearance, preferences (e.g., user interface preferences), privileges, etc. In addition, the information may consider typical user usage, user experience level, user characteristics (e.g., disabilities), etc. This information can be loaded to the tag 18 through suitable devices (not shown). By storing the information in the tag 18, the information becomes mobile and can be carried with the user. This mitigates having to enter and store such user profiles within the machine and/or employ the machine 10 to manage them, which mitigates consumption of machine storage and/or processing power.

Conveyance of information from the tag 18 to the reader 16 can be invoked in various ways. In one non-limiting example, when the tag 18 enters a communication range in which the reader 16 and the tag 18 can communicate with each other (e.g., the user with the tag 18 approaches the reader 16), the reader 16 queries the tag 18 for information, interrogates the tag 18 for information, and/or accepts information emitted by the tag 18 (e.g., where the tag 18 periodically emits information). Additionally and/or alternatively, the tag 18 can emit information to apprise the reader 16 that it has entered the range and/or the reader 16 can periodically poll for tags such as the tag 18 within its range. In addition, the information can be pushed, pulled, posted and retrieved, etc.

By way of non-limiting example, the information stored within the tag 18 can at least include user interface preferences. As the tag 18 moves nearer to the reader 16 (e.g., as the user approaches the reader 18, as the user swipes the tag 18 through the reader 16, etc.), the user interface preferences and/or other information stored within the tag 18 are provided to the reader 16. This information is conveyed to the control component 12, which uses the user interface preferences to dynamically and/or automatically customize and/or personalize the user interface 14 for the user based on the user preferences. This enables the user to be presented with a user interface with a preferred look and/or feel without having to manually configure the user interface 14. In some instances, the information conveyed by the tag 18 is used to automatically logon to the machine so that the user does not have to manually logon and/or wait for the machine 10 to retrieve and load a stored user profile. Instead, the user interface 14 is automatically configured according to the user preferences received from the tag 18 rendered such that the user can begin interacting with it.

The tag 18 and the reader 16 can periodically interact for further information conveyance, to determine whether the user is still utilizing the machine 10, etc. Usage can be determined through active user interaction (e.g., mouse, keyboard, voice, events, etc.), taking into account periods of inactivity, running applications, user motion, etc. In addition, the proximity of the tag 18 relative to the user interface 14 can be determined. When the user is finished using the machine 10 (e.g., logs off, machine idles for a defined period of time, etc.) and/or the tag 18 moves outside of a communication range with the reader 16, the control component 12 can automatically return the user interface 14 to its prior state (e.g., a default state) and/or load user preferences associated with another user with a tag 18 emitting such information.

Additionally and/or alternatively, the information conveyed from the tag 18 can include machine, reader, and/or control component preferences. For example, the information may identify one or more applications to automatically invoke on the machine 10, provide a login and/or password to access the machine 10, provide a biometric template for user authentication purposes, convey user privileges (e.g., read, write, execute, etc.) to the machine 10, etc. In another example, information may define how further information will be conveyed to the reader 16. For example, the transfer of information may be limited to emissions, queries, or reads, or any combination thereof. In yet another example, the information may include instructions for the control component 12 to execute. In another example, the tag may convey user privileges for a printing platform that permit the user to use printing platform services such as Scan to E-Mail, FAX, Scan to Network etc. It is to be appreciated that the foregoing examples are provided for illustrative purposes and are not limiting.

It is to be appreciated that tags associated with different users may concurrently provide information to the tag reader 18. For example, a first user may be interacting with the user interface 14, which has been customized based on the information (including user interface preferences) provided by a tag associated with the first user. Another user, carrying a tag with personal user interface preferences and/or other information may enters a zone in which the reader 16 can read the information from the other tag. In this situation, the control component 12 may determine that the machine 10 is still being accessed by the first user and ignore the information from the tag associated with the other user. Additionally and/or alternatively, the control component 12 may use other information such as identity, job description, security level, privileges, intelligence, etc. to determine whether the user interface preferences of the other user should override the user interface preferences of the first user. It is to be understood that these examples are provided for explanatory purposes and are not-limiting.

The information stored within the tag 18 can be serially and/or concurrently used with multiple machines. Thus, the user can use a plurality of machines wherein each machine can present a substantially similar user interface to the user based on the preferences stored within the tag 18. This allows the user to interact with different machines while interfacing with a consistent user interface, if desired by the user. In one alternative, the user interface preferences can vary by machine type such that machines of a similar type will present a substantially similar user interface to the user. The foregoing accommodates user interface differences amongst machine types. In addition, machine types can be subdivided based on other additional criteria in order to use more than one set of preferences per machine type. For instance, a machine type “computer” can be further delineated into “home computers,” “employment computers,” “school computers,” etc. wherein the user interface remains consistent within one or more of the delineations, but the user has the ability to use different sets of preferences across similar machine types. Where the tag 18 enters a zone associated with two or more different tag readers, the information can be read by two or more of the readers and corresponding user interfaces can be customized according to user interface preferences therein. Alternatively, the machines can interact (e.g., via a network, a backplane, etc.) to determine which machine the user is accessing, which could be one or more of the machines.

With reference to FIG. 2, the system further includes a tag writer 20, which, like the tag reader 16, can communicate with suitable tags, including RFID tags, contact-less smart cards, magnetic cards, data keys, transponders, and/or other information storage components. The tag writer 20 can be used to initially store information within the tag 18. Suitable initial information can include default settings and/or user provided preferences (e.g., user interface preferences) for one or more users. This information can be generated through the user interface 14 and/or other technique and/or conveyed to the tag 18 via wired and/or wireless technologies.

The tag writer 20 can also be used to update the information stored within the tag 18. Such updated information may reflect user activity (e.g., changes to the user interface 14). For instance, the control component 12, the machine 10, and/or other components such as an optional logging component 22, intelligence components (not shown), etc. can be used track the user's activity. The historical activity can subsequently by analyzed by an optional analysis component 24. Such analysis can include comparing the user preferences retrieved from the tag 18 with the tracked activity. The analysis component 24 can then notify the control component 10 when a user preference update should be written to the tag 18 and/or provide the changes to the control component 10. The control component 10 can invoke the tag writer 20 to write the changes to the tag 18 in order to update the information stored within the tag 18. It is to be appreciated that such updates can be performed dynamically as the user is using the user interface 14, upon termination a session with the user interface 14, upon demand by the user, at a predetermine interval, etc.

The analysis component 24 may not reside on the machine 10. Rather, the analysis component 24 may reside on the tag 18. The machine 10 updates the tag 18 with all user activity on the machine 10. Intelligence in the tag 18 (e.g., employing the analysis techniques described above) is employed to update the user profile on the tag 18. Thus, in some instances the tag 18 is responsible for profile management. This moves the intelligence of the profile management to the tag 18. The logging component 22 may also be hosted on the tag 18 and may additionally be used to provide an audit facility, auditing the way that the user interacts with the machine 10 and the machine functionality used by the user.

The analysis component 24 can employ various machine learning techniques, algorithms, approaches, etc. to facilitate determining suitable updates to the information stored within the tag 18. For example, the analysis component 24 can employ a machine learning algorithm that can reason about or infer from the historical activity, the identification of the user, etc. Various classification (explicitly and/or implicitly trained classifiers) schemes and/or systems (e.g., support vector machines, neural networks, expert systems, Bayesian belief networks, fuzzy logic, data fusion engines . . . ) are employed by the analysis component 24. Such classification can employ a probabilistic and/or statistical-based analysis (e.g., factoring into the analysis utilities and costs) to automatically make decisions. One example of a suitable classifier is a support vector machine (SVM). Other directed and/or undirected model classification approaches include, naïve Bayes, Bayesian networks, decision trees, neural networks, fuzzy logic models, and probabilistic classification models providing different patterns of independence, for example. Classification as used herein also is inclusive of statistical regression that is utilized to develop models of priority.

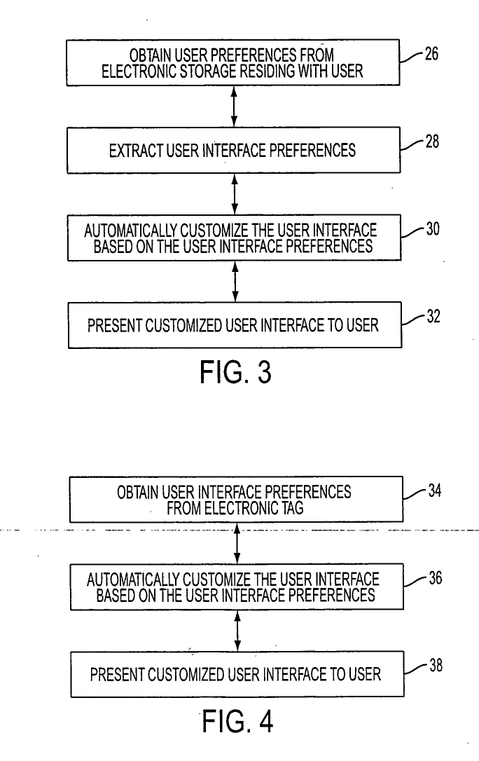

FIG. 3 illustrates a method for obtaining and employing user preferences to customize a user interface associated with a machine (e.g., a printing platform, a computer, a personal data assistant (PDA), an automobile, an entertainment system, a security system, a cell phone, a navigation system, an appliance, etc., and/or essentially any state machine). At reference numeral 26, a reader (e.g., a RFID, magnet card, smart card, etc. reader) associated with the machine obtains information regarding a user (e.g., a person, a robot, an application, another machine, etc.) of the machine. The information can be obtained from an electronic storage device (e.g., a tag) residing with the user and can include essentially any information, including user interface preferences. The information can be obtained by interrogating the storage device, receiving emissions by the storage device, and/or querying the storage device. In addition, the information can be conveyed via various wired and/or wireless communication channels. For example, as the user approaches the machine an electronic tag residing with the user can provide such information to a reading device of the machine.

At 28, the user interface preferences are extracted from the received information. The user interface preferences can indicate, among other things, the arrangement of various data input and/or output regions, including location, color, style, size, etc. and/or reflect use activity, user characteristics, user experience, etc. At 30, the user interface preferences are used to automatically customize the user interface for the user. It is to be appreciated that such customization can be performed prior to the user accessing the machine and/or upon the user accessing the machine (e.g., after logging on). In addition, the customization may involve prompting the user for additional information, mitigating entering logon information (e.g., username, password, etc.). At 32, the user is presented with the customized user interface.

Optionally, a writer can be used to write information to the electronic storage device. Such information can include user preference updates that are based on an analysis of user, etc. In one instance, user activity is logged and compared with the user preferences to determine whether any preference has changed. If so, the writer can write the changes to the electronic storage device. In another instance, intelligence is used to determine whether the writer should update the information stored within the electronic storage device. If the analysis component is hosted on the electronic tag, the writer is used to write all user machine activity to the tag.)

FIG. 4 illustrates a non-limiting particular example of a method for obtaining and employing user preference to customize a user interface of a printing platform, which includes, but is not limited to, a multifunction device that provides capabilities such as printing, copying, scanning, faxing, emailing, etc. It is to be appreciated that the printing platform is associated with the control component 12, the interface 14, the tag reader 16, the tag writer 20, and, optionally, the analysis component 24 and/or the user activity log 22 as described in detail above. In addition, one or more users of the printing platform may be carrying the electronic tag 16, which stores personal information, including printing platform user interface preferences.

At 34, a user with an electronic storage tag enters a zone of a tag reader, and the tag conveys information to the tag reader. Such information can be obtained through a direct read of the tag, a query and response by the tag, and/or periodic emission of information by the tag. The information includes user interfaces preferences, which can be extracted from the received information. At 36, the user interface preferences are analyzed, loaded, and used to automatically customize a user interface of the printing platform for the user. At 38, the user is presented with the customized user interface. The user can use the customized interface to interact with the printing platform, for example, for scanning, emailing, copying, printing, etc. Optionally, the activity of the user can be tracked. The tracked activity can be compared with the received user interface preferences for change. For instance, the user may have manually changed the look and/or feel of the user interface. In another instance, the user may be using a different style and/or options with a greater frequency. It may be determined that the change in usage reflects a preference change. As a result, the user interface preferences stored on the tag can be updated based upon at least in part on the different activity of the user.

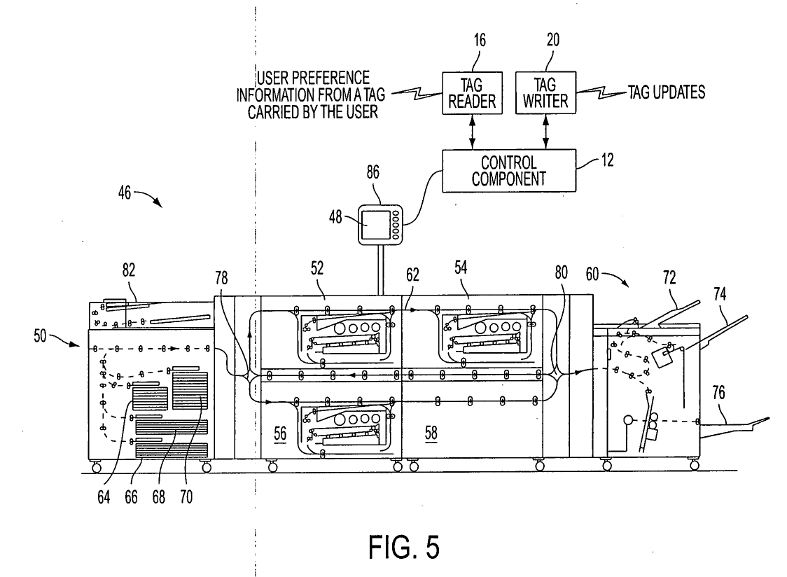

With reference to FIG. 5, an exemplary printing platform 46 that automatically customizes its user interface based on user preferences obtained from a storage component carried by a user is illustrated. The printing platform 46 includes a user interface 48, which can be substantially similar to the user interface 14 described in detail above. The user interface 48 provides mechanism in which a user (e.g., a person, a robot, an application, another machine, etc.) can interact with the printing platform 46. For example, the user can interact with the user interface 48 to navigate through menus, select options, configure the printing platform 46, activate a particular function in connection with a multi-functional platform (e.g., print, copy, scan . . . ), retrieve messages, etc. By way of example, a user desiring to produce several copies of a document can interact with the user interface 48 to activate a copy menu, input a number of copies, define paper type (e.g., letter, A4 . . . ), set paper quality (e.g., resolution) and color (e.g., grey scale, color . . . ), etc.

The printing platform 46 further includes the tag reader 16, which can obtain user preference information (e.g., defined by the user, determined based on usage, default, inferred, etc.) as well as other information stored within a tag (e.g., the tag 18), which can be carried by the user. Typically, the information is conveyed to the tag reader 16 upon the tag entering a communication region (e.g., a magnetic card moving across a reading interface of the reader 16, signals emitted by the tag, etc.) of the tag reader 16. The information can be communicated via various communication channels and/or ports using wired and/or wireless technologies.

The control component 12 retrieves user interface preferences from the received information and uses these preferences to automatically customize the user interface 48 for the user. By way of example, the user interface 48 may be initially configured based on the most used or popular features (as determined by the manufacturer, administrator, etc.) For instance, the default menu may be directed toward making copies. The options within the menu may also include default settings, for example, associated with paper size, number of copies, collation, sorting, etc. The user preferences obtained from the tag by the reader 16 may differ from these settings. For instance, this particular user may prefer to begin with a scanning menu. In another instance, the user may desire to begin with the copying menu, but may prefer different settings. For example, the default paper size may be A4, whereas the user may prefer this setting to be legal size. In another example, the default settings may specify a paper tray, whereas the user may desire to manually feed paper. In yet another example, the default settings may be for single sided marking, whereas the user may desire to make doubled sided markings. The control component 12 obtains the user interface preferences and automatically loads them for the user.

The control component 12 or other component(s) can track user activity and update the user interface preferences stored within the tag via the tag writer 20. For instance, a user with paper size preferences that differ from the default settings will have his/her preferred paper size setting automatically loaded upon accessing the printing platform 46. Over time, the user's paper size preferences may change (e.g., from A4 to letter). The changed behavior can be observed and analyzed by the printing platform 46. The control component 12 can employ various machine learning techniques, algorithms, approaches, etc. to facilitate determining if the user's behavior has changed and provide suitable updates to the information stored within the tag. In one instance, user preferences are automatically updated when the platform 46 determines such an updated will most likely benefit the user. For example, if the user consistently alters the loaded user preferences. In another instance, the printing platform 46 notifies the user that it has observed a change in behavior and automatically updates the information within the tag to reflect the new behavior. In another instance, the printing platform 46 notifies the user that it has observed a change in behavior and waits for the user to invoke the update.

When the user is finished using the printing platform 46 (e.g., logs off, machine idles for a defined period of time, etc.) and/or moves outside of the defined proximity, the control component 12 can dynamically return the user interface 46 to its default, previous state, and/or load another user's preferences.

It is to be appreciated that the printing platform 46 can be a multi-functional platform for copying, scanning, printing, faxing, emailing, etc. The platform 46 includes a plurality of units or elements 50, 52, 54, 56, 58 and 60 that are interconnected by a print media conveyor 62. The processing units cooperate to process print jobs. While this example illustrates six processing units, it is to be understood that the processing platform can include L processing units, where L is an integer equal to or greater than one. In some instances, one or more of the processing units 50-60 are removable. For example, the functional portion (e.g., marking engine) of the processing unit 58 is shown as removed, leaving only the external housing or mounting fixture through which the print media conveyor 62 passes. Some or all of the processing units 50-60 may be identical to provide redundancy or improved productivity through parallel printing. Alternatively or additionally, some or all of the processing units 50-60 may be different to provide different capabilities. For example, the processing units 52 and 54 may include color marking engines, while the processing units 56 may include a black (K) marking engine. The processing units 52-58 can employ various technologies such as xerographic printing, ink jet transfer, thermal impact printing, and/or other technologies.

The processing unit 50 is a print media source processing unit that supplies paper or other print media for marking, and the processing unit 60 is a finisher that provides finishing capabilities such as collation, stapling, folding, stacking, hole-punching, binding, postage stamping, or so forth. The print media source processing unit 50 includes print media sources 64, 66, 68 and 70 connected with the print media conveyor 62 to provide selected types of print media. While four print media sources are illustrated, K print media sources can be employed, wherein K is an integer equal to or greater than one. Moreover, while the illustrated print media sources 64-70 are embodied as components of the dedicated print media source processing unit 50, in other instances one or more of the marking engines may include its own dedicated print media source instead of or in addition to those of the print media source processing unit 50.

Each of the print media sources 64-70 can store sheets of the same type of print medium, or can store different types of print media. For example, the print media sources 64 and 66 may store the same type of large-size paper sheets, print media source 64 may store company letterhead paper, and the print media source 70 may store letter-size paper. The print media can be substantially any type of medium upon which one or more of the processing units 52-58 can print, such as: high quality bond paper, lower quality “copy” paper, overhead transparency sheets, high gloss paper, and so forth.

The print media conveyor 62 is controllable to acquire sheets of a selected print medium from the print media sources 64-70, transfer each acquired sheet to one or more of the processing units 52-58 to perform selected marking tasks, transfer each sheet to the finisher 60 to perform finishing tasks according to a job description associated with each sheet and according to the capabilities of the finisher.

The finisher unit 60 includes one or more print media destinations 72, 74, and 76. While three destinations are illustrated, the printing platform 46 may include X print media destinations, where X is an integer greater than or equal to one. The finisher unit 60 deposits each sheet after the processing in one of the print media destinations 72-76, which may be trays, pans, or so forth. While only one finisher is illustrated, it is contemplated that two, three, four or more finishers can be employed in the printing platform 48.

The print media conveyor 62 passes through each intermediate processing unit 52-58 to provide a bypass route by which the sheets can pass through the processing unit without interacting therewith. Branch paths are also provided in each processing unit 52-58 to take the sheet off the conveyor 62 and into the functional portion of the processing unit and to deliver the processed sheet back to the conveyor 62. In the processing unit 58, the branch paths are presently removed along with the functional portion; however, the bypass portion of the conveyor 62 remains in the processing unit 58 so as to maintain continuity of the print media conveyor 62. The conveyor 62 may also include other branch junction points such as the example branch junction points 78 and 80 to enable the conveyor to pass sheets along selected paths in the illustrated multiple-path conveyor configuration. This enables the illustrated arrangement in which the marking engine processing units 52-58 are arranged two-dimensionally. In a linear arrangement of processing units (not illustrated), the branch junction points 78 and 80 are suitably omitted.

The printing system 48 executes print jobs. Print job execution involves printing selected text, line graphics, images, machine ink character recognition (MICR) notation, or so forth on front, back, or front and back sides or pages of one or more sheets of paper or other print media. In general, some sheets may be left completely blank. In general, some sheets may have mixed color and black-and-white printing. Execution of the print job may also involve collating the sheets in a certain order. Still further, the print job may include folding, stapling, punching holes into, or otherwise physically manipulating or binding the sheets. The printing, finishing, paper handling, and other processing operations that can be executed by the printing system 46 are determined by the capabilities of the processing units 50-60 of the printing system 46. Those capabilities may increase over time due to addition of new processing units or upgrading of existing processing units. Those capabilities may also decrease overtime due to failure or removal of one or more processing units, such as the illustrated removed functional portion of processing unit 58.

Print jobs can be supplied to the printing system 46 in various ways. A built-in optical scanner 82 can be used to scan a document such as book pages, a stack of printed pages, or so forth, to create a digital image of the scanned document that is reproduced by printing operations performed by the printing system 46. Alternatively, a print job can be electronically delivered to a system controller (not shown) via a wire or wireless connection by a remote device such as another print platform, a computer, etc. For example, a network user operating word processing software running on a remote computer may select to print the word processing document on the printing system 46, thus generating a print job, or an external scanner (not shown) connected to the network may provide the print job in electronic form. It is also contemplated to deliver print jobs to the printing system 48 in other ways, such as by using an optical disk reader (not illustrated), or using a dedicated computer connected only to the printing system 46.

The user interacts with the user interface 48 to navigate through menus, select options, configure the printing platform 46, activate a particular function in connection with a multi-functional platform (e.g., print, copy, scan . . . ), retrieve messages, etc. By way of example, a user desiring to produce several copies of a document can interact with the user interface 48 to activate a copy menu, input a number of copies, define paper type (e.g., letter, A4 . . . ), set paper quality (e.g., resolution) and color (e.g., grey scale, color . . . ), etc. This information is provided to the control component 12, which executes instructions to produce the copies based on the user input.

The printing platform 46 is an illustrative example. In general, any number of print media sources, media handlers, marking engines, collators, finishers or other processing units can be connected together by a suitable print media conveyor configuration. While the printing platform 46 illustrates a 2×2 configuration of four marking engine processing units 52-58, buttressed by the media source unit 50 on one end and by the finisher unit 60 on the other end, other physical layouts can be used, such as an entirely horizontal arrangement, stacking of processing units three or more units high, or so forth. Moreover, while in the printing platform 46 the marking engine processing units 52-58 have removable functional portions, in some other embodiments some or all processing units may have non-removable functional portions and/or field replaceable units. It will be appreciated that even if the functional portion is non-removable, the provision of the print media conveyor 62 with bypass paths through each intermediate processing unit enables the processing unit to be taken “off-line” for repair or modification while the remaining processing units of the printing system continue to function as usual.

In some embodiments, separate bypasses for intermediate components may be omitted. The “bypass path” of the conveyor in such configurations suitably passes through the functional portion of a processing unit, and optional bypassing of the processing unit is effectuated by conveying the sheet through the functional portion without performing any processing operations. Still further, in some embodiments the printing system may be a cluster of networked or otherwise logically interconnected printers each having its own associated print media source and finishing components.

The plurality of processing units 50-60 and flexible print media conveyor 62 enables the printing platform 46 to have a large number of capabilities and features. Each marking engine 52-56, for example, has associated low-level print settings such as xerographic voltages, fuser temperatures, toner reproduction curves, and so forth. Some of these low-level print settings are optionally modified depending upon the sequence along which a given sheet passes through the printing platform 46; for example, it may be advantageous to modify the fusing temperatures of serially performed xerographic processes. At a higher functional level, each marking engine has associated functional parameters such as contrast, resolution, and so forth.

It will be appreciated that variations of the above-disclosed and other features and functions, or alternatives thereof, may be desirably combined into many other different systems or applications. Various and variant embodiments presently unforeseen or unanticipated alternatives, modifications, variations or improvements therein may be subsequently made by those skilled in the art which are also intended to be encompassed by the following claims. In addition, the claims can encompass embodiments in hardware, software, or a combination thereof. Moreover, the term “printer,” “print,” and variations thereof as used herein encompass any apparatus, such as a digital copier, bookmaking machine, facsimile machine, multi-function machine, etc. which performs a print outputting function for any purpose.

1. A machine, comprising:
a user interface for interacting with a user;
a reader that obtains personal user interface preferences for the user from an electronic tag residing with the user; and
a control component that customizes the user interface based at least in part on the personal user interface preferences.

2. The machine as set forth in claim 1, wherein the reader reads RFID tags, a contact smart card, contact-less smart card, magnetic cards, and data keys.

3. The machine as set forth in claim 1, wherein the tag is one of a RFID tag, a contact smart card, a contact-less smart card, a magnetic card, and a data key.

4. The machine as set forth in claim 1, wherein the user interface is automatically customized upon receipt of the use interface preferences.

5. The machine as set forth in claim 1, wherein the control component restores previous user interface configuration when the user is finished using the machine.

6. The machine as set forth in claim 1, further comprising a writer that writes information to the electronic tag.

7. The machine as set forth in claim 6, wherein the writer updates the user interface preferences stored in the electronic tag based on a difference between tracked user activity and the received user interface preferences.

8. The machine as set forth in claim 1, further including an analysis component that compares user activity with the loaded user interface preferences to determine whether preferences of the user changed over time.

9. The machine as set forth in claim 8, wherein the analysis component resides within one of the machine and the electronic tag.

10. The machine as set forth in claim 1, wherein the user interface preferences are used in connection with multiple similar machines in order to maintain a consistent look and feel across machines.

11. The machine as set forth in claim 1, wherein the user interface is one of a graphical user interface and a command line interface.

12. The machine as set forth in claim 1, wherein the machine is a printing platform.

13. The machine as set forth in claim 1, wherein the user interface preferences are based on at least one or more of user experience, user historical activity, and user personal characteristics.

14. A method for automatically customizing an interface of a machine for a particular user, comprising:
reading personal preferences for a user from an electronic tag residing with the user;
analyzing the personal preference; and
presenting a customized user interface to the user based on the personal preferences.

15. The method as set forth in claim 14, further comprising:
tracking user interaction with the customized user interface; and
updating the personal preferences stored in the electronic tag based at least in part on the tracked user interaction.

16. The method as set forth in claim 15, further comprising employing intelligence to facilitate tracking the user interaction and updating the electronic tag.

17. The method as set forth in claim 14, further comprising restoring the user interface to a previous state when the user is finished using the machine.

18. The method as set forth in claim 14, further comprising using the personal preferences to automatically log the user onto the machine.

19. A printing platform programmed to perform the acts of method 14.

20. A xerographic device, comprising:
a tag reader that obtains personal preferences for a user from an electronic tag, which is associated with one or more of a RFID tag, a contact smart card, a contact-less smart card, a magnetic card, and a data key; and
a control component that automatically configures a user interface of the xerographic device for the user based at least in part on the user personal preferences.
